(19) United States
(12) Patent Application Publication
(10) Pub. No.: US 2025/0145159 A1
(43) Pub. Date: May 8, 2025

(54) INTUITIVE TRAILER BACKUP SYSTEM

(71) Applicant: GM GLOBAL TECHNOLOGY OPERATIONS LLC, Detroit, MI (US)

(72) Inventors: Vincent Wei, Brechin (CA); Kun Zhao, Markham (CA)

(73) Assignee: GM GLOBAL TECHNOLOGY OPERATIONS LLC, Detroit, MI (US)

(21) Appl. No.: 18/504,475

(22) Filed: Nov. 8, 2023

(51) Int. Cl. B60W 30/18; B60W 50/14; B62D 15/02

(52) U.S. Cl. CPC B60W 30/18036; B60W 50/14; B62D 15/025; B60W 2510/20; B60W 2520/06; B60W 2556/45

(57) ABSTRACT

Methods and apparatus are provided for performing an assisted driving trailer reversing operation including a user interface configured to generate an initiation signal in response to a user input, a processor configured to generate a control signal in response to the initiation signal indicative of an inverse steering ratio, a steering angle sensor to detect a steering direction and a steering angle from a center steering position, a steering controller configured to receive the steering angle and the steering direction from the steering angle sensor, to invert the steering angle to generate an inverted steering angle such that the inverted steering angle has a same angular magnitude as the steering angle and an opposite direction than the steering direction, and a vehicle control system for controlling a movement of a vehicle in response to the inverted steering angle.

### INTRODUCTION

The present disclosure relates generally to a system of providing an automated trailer backup system in a motor vehicle. More specifically, aspects of the present disclosure relate to systems, methods and devices for providing a user input to reverse a steering controller input in a trailering application to provide intuitive steering control with a motor vehicle trailering condition.

Pulling a trailer with a tow vehicle has always been and remains a complicated endeavor for many drivers and automated driving systems. A ball hitch is typically employed as a trailer connection and provides a joint between the tow vehicle and the trailer. Aiming the trailer involves turning the rear of the tow vehicle in the opposite direction of the desired direction of the trailer. The geometry of reversing a trailer and having the trailer finish in the desired location can be a daunting task for many drivers. In addition, driver sight lines are often obstructed by the trailer, thereby requiring a second person external to the vehicle to obtain visual confirmation and provide feedback for the driver during a reversing operation. Furthermore, currently employed systems require additional hardware, such as rotational knobs, and add cost and visual complexity to the vehicle. It would be desirable to provide improved trailer control for a vehicle operator during reverse trailering operations while overcoming the aforementioned problems.

The above information disclosed in this background section is only for enhancement of understanding of the background of the invention and therefore it may contain information that does not form the prior art that is already known in this country to a person of ordinary skill in the art.

### SUMMARY

Disclosed herein are vehicle control methods and systems and related control logic for provisioning vehicle systems, methods for making and methods for operating such systems, and motor vehicles equipped with onboard control systems. By way of example, and not limitation, there is presented various embodiments of systems for an assisted trailer backup system in a motor vehicle and a method for intuitive steering control for trailering reverse operations in a motor vehicle are disclosed herein.

In accordance with an aspect of the present disclosure, a steering control system including a user interface configured to generate an initiation signal in response to a user input, a steering angle sensor to detect a steering direction and a steering angle from a center steering position, a steering controller configured to receive the steering angle and the steering direction from the steering angle sensor, to invert the steering angle in response to the initiation signal, the steering angle and the steering direction, to generate an inverted steering angle such that the inverted steering angle has a same angular magnitude as the steering angle and an opposite direction than the steering direction, and a vehicle control system for controlling a movement of a vehicle in response to the inverted steering angle.

In accordance with another aspect of the present disclosure, a direction sensor configured to detect a direction of propulsion of the vehicle and wherein the inverted steering angle is generated in response to the direction of propulsion being in a reverse direction.

In accordance with another aspect of the present disclosure, a trailer interface configured to detect a trailer connection and wherein the inverted steering angle is generated in response to a detection of a connected trailer.

In accordance with another aspect of the present disclosure, wherein the inverted steering angle is calculated in response to multiplying the steering angle by a negative unity value

In accordance with another aspect of the present disclosure, wherein the user interface is generated by a software application on a mobile device and wherein the initiation signal is transmitted via a wireless network to the steering controller.

In accordance with another aspect of the present disclosure, wherein the user interface is generated by a software application and is displayed on a vehicle infotainment display.

In accordance with another aspect of the present disclosure, a direction sensor configured to detect a direction of propulsion of the vehicle and wherein the vehicle control system is configured to control the vehicle in response to the inverted steering angle in response to a reverse detected direction of propulsion and to control the vehicle in response to the steering angle in response to a detected change in the direction of propulsion from the reverse detected direction of propulsion to a forward detected direction of propulsion.

In accordance with another aspect of the present disclosure, wherein the vehicle control system is further configured to detect a direction of propulsion and a trailer connection state and to generate a user alert in response to the direction of propulsion being in a forward direction and the trailer connection state indicating an absence of a connected trailer.

In accordance with another aspect of the present disclosure, wherein the steering controller is configured to perform a variable rate steering algorithm and wherein the inverted steering angle has an opposite value to the steering angle.

In accordance with another aspect of the present disclosure, a method for controlling a steering of a vehicle including receiving, by a user interface, a user input indicative of an initiation of a reverse steering feature, detecting, by a steering sensor, a steering angle, generating, by a vehicle control system, an inverted steering angle by inverting the steering angle such that the inverted steering angle has an opposite steering direction to that of the steering angle, and controlling, by the vehicle control system, a motion path of the vehicle in response to the inverted steering angle.

In accordance with another aspect of the present disclosure, detecting, by a trailer interface, a presence of a trailer and wherein the inverted steering angle is generated in response to a detection of a connection to the trailer.

In accordance with another aspect of the present disclosure, detecting, by the vehicle control system, a direction of propulsion and wherein the inverted steering angle is generated in response to the direction of propulsion being in a reverse direction.

In accordance with another aspect of the present disclosure, controlling, by the vehicle control system, the motion path of the vehicle in response to the steering angle in response to detecting a change in a propulsion direction state from a reverse direction state to a forward direction state.

In accordance with another aspect of the present disclosure, detecting, by a trailer interface, a change in capacitance between two connection in a trailer connection and wherein the inverted steering angle is generated in response to the detection of the change in capacitance.

In accordance with another aspect of the present disclosure, wherein the vehicle is controlled in response to the inverted steering angle in response to the vehicle being used in a trailering operation.

In accordance with another aspect of the present disclosure, wherein the user interface is generated by a software application on a mobile device and where the user input is transmitted via a wireless network to the vehicle control system.

In accordance with another aspect of the present disclosure, wherein the user interface is generated by a software application on a vehicle infotainment system and where the user input is transmitted via a controller area network bus to the vehicle control system.

In accordance with another aspect of the present disclosure, wherein the user interface is a physical button mounted within a vehicle cabin and wherein the user input is a voltage changed detected by the vehicle control system.

In accordance with another aspect of the present disclosure, a driver assistance system including a sensor configured to generate a trailer control signal in response to a detection of a trailer, a vehicle propulsion system for detecting a propulsion direction state, a user interface for receiving a user input and for generating an initiation signal in response to the user input, a steering sensor configured to detect a steering wheel position, a vehicle control processor for calculating a steering angle in response to the steering wheel position, and for calculating an inverse steering angle in response to the initiation signal and the trailer control signal being indicative of a connected trailer, and a steering controller for controlling a steering direction of the a vehicle in response to the inverse steering angle in response to the propulsion direction state being in a reverse direction, and the steering angle in response to the propulsion direction state being in a forward direction.

In accordance with another aspect of the present disclosure, wherein the inverse steering angle such that the inverted steering angle has a same angular magnitude as the steering angle and an opposite direction of the steering angle.

### BRIEF DESCRIPTION OF THE DRAWINGS

The exemplary embodiments will hereinafter be described in conjunction with the following drawing figures, wherein like numerals denote like elements, and wherein:

FIG. 1 shows an application for the method and apparatus for an intuitive trailer steering system in a motor vehicle according to an exemplary embodiment of the present disclosure.

FIG. 2 shows an image of an exemplary user interface for use in an intuitive trailer steering system in a motor vehicle according to an exemplary embodiment of the present disclosure.

FIG. 3 shows a block diagram of an exemplary system for an intuitive trailer steering system in a motor vehicle according to an exemplary embodiment of the present disclosure.

FIG. 4 shows a flow chart illustrating a method for controlling an intuitive trailer steering system in a motor vehicle according to an exemplary embodiment of the present disclosure.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

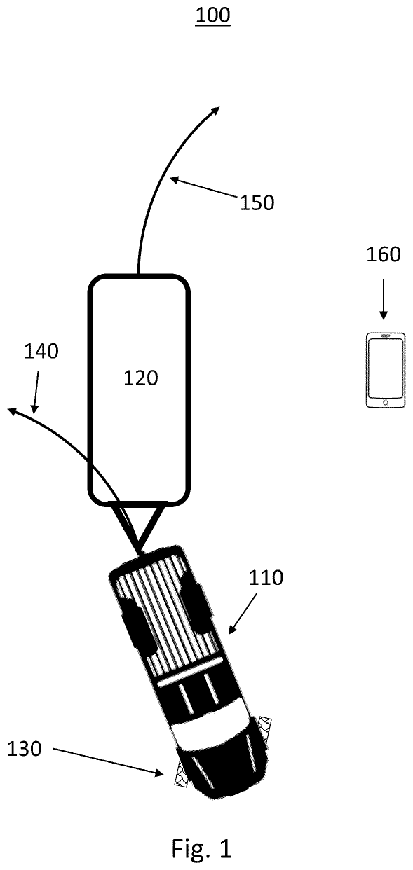

Turning now to FIG. 1, an exemplary system 100 for an intuitive trailer steering system in a motor vehicle is shown. The exemplary system 100 shows a towing vehicle 110 equipped with the exemplary system, a trailer 120, and a remote device 160. The exemplary system 100 is also illustrative of an expected towing vehicle reverse path 140 and a resultant expected trailer reverse path 150. In addition, the front vehicle tires 130 are shown in a position corresponding to the expected towing vehicle reverse path 140.

It is desirable to provide a system for helping drivers reverse a trailer with a towing vehicle. Even experienced trailer operators may sometimes have difficulty judging dimensions and the geometry of a trailer reversing operation and may have to repeat the operation several times before the trailer ends up in the desired location. One of the primary problems that makes backing up a trailer less than intuitive is that the driver must turn the steering wheel in a direction counter to the desired direction of travel of the trailer 120. In the exemplary system, the front vehicle tires 130 are turned towards the driver's right, and the resultant expected towing vehicle reverse path 140 is toward the driver's left.

In some exemplary embodiments, the user can be provided with a user interface on the remote device 160 for engaging and disengaging the intuitive trailer steering feature. In other exemplary embodiments, the user interface can be presented on a user display on a vehicle user interface, a vehicle infotainment system or can be an application on the remote device 160, such as a mobile device communicatively coupled with a vehicle controller. In some exemplary embodiments the remote device 160 running a software application can receive a user input, such as a virtual button push. The software application can then transmit a command via a wireless network to the towing vehicle control system to reverse the steering angle such that turning the steering wheel to the right, turns the front wheels to the left and vice versa. While in intuitive trailer steering mode, the resultant trailer reverse path would be in the same direction that the driver is turning the steering wheel. Thus, to move the trailer to the left, the driver would turn the steering wheel to the left. Turning the steering wheel to the right in intuitive trailer steering mode would turn the towing vehicle wheels to the right.

Modern steering controllers can be fully electronic systems, or “fly by wire” systems, which use electronic signals to control actuators and motors to control the steering angle. Electronic steering controllers allow a vehicle to be steered without a physical connection between the steering wheel and the wheels. Instead, the steering wheel can be connected to electronic steering sensors that can detect a steering wheel position and transmit the steering wheel positions to a computer, which then controls actuators that turn the wheels in response to the steering wheel position. These electronic steering controllers can allow for variable steering ratios which allow the steering controller to adjust the ratio between the rotation of the steering wheel and the angle of the front wheels by adjusting an electronic ratio value in an electronic controller. In some exemplary embodiments, the steering controller can apply a negative steering ratio, such as a 1:−1 ratio, when the intuitive trailer steering feature is enabled.

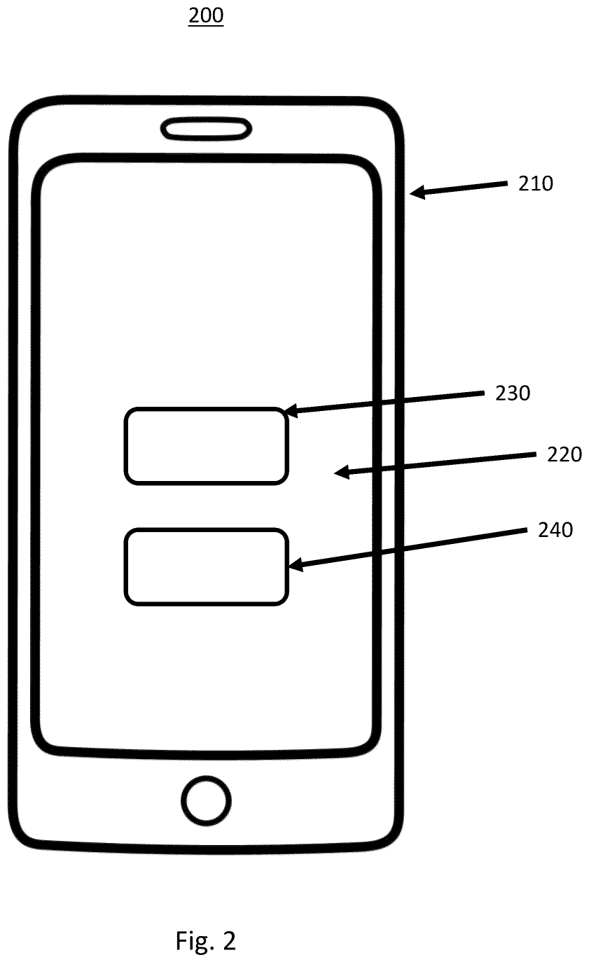

Turning now to FIG. 2, an exemplary user interface 200 for the method and apparatus for an intuitive trailer steering system in a motor vehicle is shown. The exemplary user interface 200 shows a mobile device 210 with a display 220 for displaying a software application. The software application can be a simple user interface which enables the reception of user selections to enable and disable the intuitive trailer steering feature in the host vehicle. In some exemplary embodiments, the user may start the software application on the mobile device and be presented with the intuitive trailer steering interface. The user can then select the enable soft button on the display. In response to the user selecting the enable soft button, the software application can then generate a control signal requesting enablement of the intuitive trailer steering system on the host vehicle. The control signal can be transmitted via a wireless network, such as a cellular communications network to the host towing vehicle. The host towing vehicle can then enable the intuitive trailer steering system in response to the received control signal.

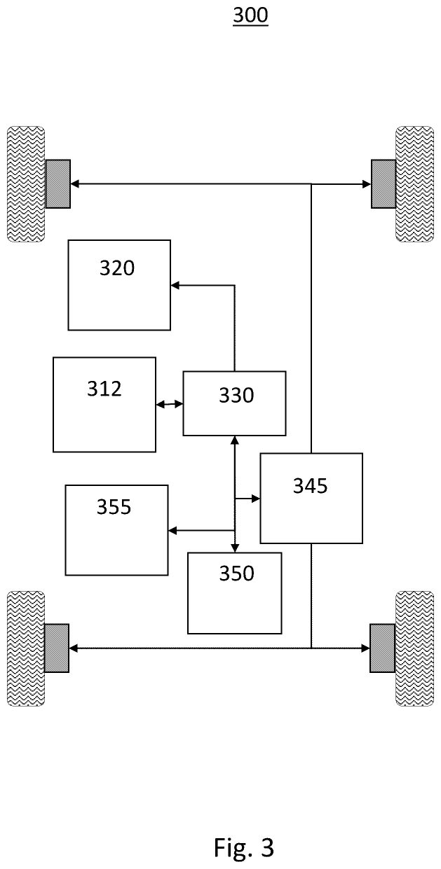

Turning now to FIG. 3, a block diagram of an exemplary system 300 for an intuitive trailer backup system in a motor vehicle is shown. The system 300 may include a processor 330, a steering controller 345, a user interface module 320, trailer interface 350, a network interface 312.

The steering controller 345 is configured to control the direction of the vehicle by adjusting the steering angle of the front wheels relative to the centerline of the vehicle. The steering controller 345 typically employs a closed-loop configuration and receives steering angle feedback from sensors to adjust the steering control output. The steering controller 345 can be an electronic steering controller using a steering processor performing a steering algorithm to adjust steering control motors and actuators in response to received inputs, such as via a steering wheel. The steering algorithm can adjust a steering ratio or other steering parameters in response to driving conditions, vehicle speed and/or driver preferences.

Advantageously, the steering ratio can be adjusted by the steering algorithm to enable the intuitive trailer steering feature. In some exemplary embodiments, a negative steering ratio can be applied when the vehicle is used to reverse a trailer, such as a 1:−1 ratio. When the steering wheel is turned to the right, the front wheels are turned to the left.

This negative steering wheel ratio can be requested to be engaged by the driver via the user interface. In some exemplary embodiments, the negative steering wheel ratio can be engaged when the vehicle transmission is in a reverse state and a trailer connection is detected at the trailer interface 350.

The exemplary system 300 can further include a trailer interface 350 for detecting and communicating with a trailer electrical system. The trailer interface 350 can include electrical connections for enabling turn signals, brake lights, running lights, tail lights, and reverse lights. The trailer interface 350 can further be configured to detect a presence of a trailer, such as in response to an electrical connection, a change in resistance and/or capacitance between conductors in the electrical connections, or through depression of a switch or the like when the trailer connector is inserted into the vehicle side trailer connector socket. In some exemplary embodiments, the steering controller 345 and/or the processor 330 can receive the indication of the trailer connection and in response, can enable a trailering mode. In some exemplary embodiments, the intuitive trailer steering feature may be restricted to being enabled only while the tow vehicle is in the trailering mode.

The steering controller 345 and/or the processor 330 can further be communicatively coupled with a vehicle controller 355 for determining a vehicle transmission state or vehicle propulsion direction. In some exemplary embodiments, the intuitive trailer steering feature may be restricted to being enabled only while the tow vehicle and/or the vehicle transmission is in a reverse mode. Thus, when the driver is reversing with the trailer, the intuitive trailer steering feature is engaged, such as application of a negative steering ratio to the steering controller. When the towing vehicle is shifted into a forward propulsion mode, the intuitive trailer steering feature can be disengaged and the tow vehicle will steer as expected in a conventional driving mode.

The user interface 320 may include a touch screen display operative to display a software application for enabling the intuitive trailer steering feature. The software application can include one or more soft buttons displayed on the touch screen display allowing a user to select a soft button associated with enabling the intuitive trailer steering feature. The user interface 350 may be operative to receive a user input indicating a request to initiate a trailering mode or to initiate the intuitive trailer steering feature and/or to disable the intuitive trailer steering feature. Alternatively, the user interface for engaging and disengaging the intuitive trailer steering feature can be a standard mechanical button or dial located on a dashboard, center console, transmission shifter or the like for coupling a voltage or initiating a change in voltage level, to a vehicle controller.

The processor 330 may be a vehicle control processor, driver assistance processor, or other vehicle processor and may perform various vehicle control algorithms. The processor 330 can be communicatively coupled to the user interface 320 for receiving a intuitive trailer steering feature enable command and/or the network interface 312 for receiving the intuitive trailer steering feature enable command via a wireless network.

In an exemplary embodiment, the processor 330 may perform the intuitive trailer steering algorithm in response to the received enable command. The feature enablement can further be conditioned on a vehicle transmission or drive state being in a reverse condition and/or detection of a trailer via the trailer interface 350. In some exemplary embodiments, the processor can then use a negative steering ratio or the like when calculating steering control angles and coupling these steering control angles to the steering controller 345. In some exemplary embodiments, the processor 330 can couple the steering ratio to the steering controller 345 indicative of the reverse steering ratio and the steering controller can control the steering angle in response to the steering ratio and the steering wheel position. In another exemplary embodiment, the processor 330 can include the vehicle controller 355 and/or the steering controller 345 or can communicate directly with a throttle controller, brake controller and/or steering controller 345 directly.

The vehicle controller 345 may be operative to receive control signals from the processor 330 and to control the host towing vehicle in response to these control signals. The control signals may include specific navigational route information, may include the destination location, or may include specific steering control, throttle control and braking control instructions.

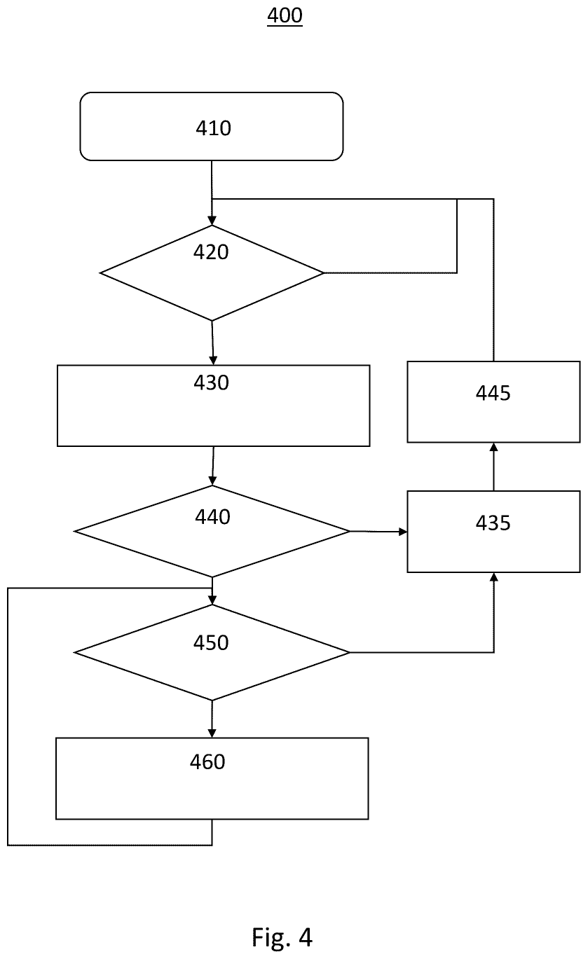

Turning now to FIG. 4, a flow chart illustrating an exemplary method for an automated trailer backup system in a motor vehicle 400 according to an exemplary embodiment of the present disclosure is shown. The method 400 if first initiated in response to a vehicle initiation 410. The vehicle initiation 410 can occur in response to a vehicle control system being initiated, a vehicle propulsion state being transitioned from an off state to a standby state or from a standby state to a run state. In some exemplary embodiments, the vehicle control system algorithm can be initiated in response to a control signal from a vehicle key fob or control signal generated by a mobile device in response to an activation via a software application run on the mobile device. The control signal can be transmitted from the mobile device via a wireless network to the vehicle to initiate the vehicle control algorithm.

The method 400 is next operative to monitor 420 for an initiation control signal for the intuitive trailer steering algorithm. The method 400 may periodically check for receipt of the initiation control signal. In some exemplary embodiments, the initiation control signal can be generated in response to a user input received by a software application on a mobile device, can be received from a vehicle user interface, such as an infotainment system, a vehicle mounted pushbutton or switch, or received from a vehicle key fob in response to a user pushing a button on the vehicle key fob. If no initiation control signal for the intuitive trailer steering algorithm is received, the method 400 can return to periodic monitoring 420 for the initiation control signal.

If the initiation control signal for the intuitive trailer steering algorithm is received, the method 400 next enables 430 the intuitive trailer steering algorithm. In some exemplary embodiments, the intuitive trailer steering algorithm may determine if 440 a trailer is connected. A trailer connection can be determined in response to a change in resistance, voltage or capacitance between one or more trailer connector pins, can be detected by a pressure sensor coupled to a tow vehicle mounted trailer hitch or trailer hitch ball, or can detect the presence of a trailer using a tow vehicle rear camera. Alternatively, the trailer can include a identifier which can be detected either wirelessly or by data transmitted via the trailer connector. If the trailer is equipped with trailer brakes, the braking controller of the tow vehicle can detect the presence of the trailer in response to an application of the tow vehicle brakes.

In some exemplary embodiments, if no trailer is detected, the method 400 can transmit 435 an error code to a user interface, such as the software application on the mobile device indicative that no trailer is detected. In some instances, the software application can allow the user to override the trailer detection to continue the intuitive trailer steering algorithm. The method 400 can next disable 445 the algorithm and return to periodic monitoring 420 for a subsequent initiation control signal.

If the trailer connection is detected, the method 400 is next operative to determine 450 if the tow vehicle propulsion state is in reverse. The propulsion state can be determined in response to a transmission gear selector being in reverse or a propulsion mode determined by a vehicle controller in response to a current state of the propulsion algorithm. In some exemplary embodiments, the method can prompt a user to shift the vehicle into reverse if the vehicle is in a park state. If the vehicle is not in a reverse state, or the vehicle is not shifted into a reverse state within a predetermined period of time, such as 5 seconds, or if a vehicle accelerator is pressed while the vehicle propulsion state or transmission is in a forward mode or gear. The method can transmit 435 an error code to the user indicative of the vehicle not being in a reverse mode. The method 400 can then disable 445 the algorithm and return to periodic monitoring 420 for a subsequent initiation control signal.

If the vehicle propulsion state or the transmission state is indicative of a reverse mode, the method 400 can then apply 460 the reverse steering ratio to the steering controller. The steering controller then reverses the steering direction of the front wheels as compared with the rotation of the steering wheel. If the steering wheel is turned towards the left, the wheels turn to the right. In some exemplary embodiments, the reverse steering ratio can be indicated by an inversion of the steering control signal or an application of a −1:−1 steering ratio. During the intuitive trailer steering function when the reverse steering ratio is applied, the method 400 is operative to periodically determine if the vehicle propulsion state is still in reverse 450. If the tow vehicle is shifted out of reverse, say into drive, the method 400 applies a standard steering ratio, such as 1:1, such that the turning direction of the steering wheel corresponds with the steering direction of the towing vehicle front wheels.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A steering control system comprising:
a user interface configured to generate an initiation signal in response to a user input;
a steering angle sensor to detect a steering direction and a steering angle from a center steering position;
a steering controller configured to receive the steering angle and the steering direction from the steering angle sensor, to invert the steering angle in response to the initiation signal, the steering angle and the steering direction, to generate an inverted steering angle such that the inverted steering angle has a same angular magnitude as the steering angle and an opposite direction than the steering direction; and
a vehicle control system for controlling a movement of a vehicle in response to the inverted steering angle.

2. The steering control system of claim 1 including a direction sensor configured to detect a direction of propulsion of the vehicle and wherein the inverted steering angle is generated in response to the direction of propulsion being in a reverse direction.

3. The steering control system of claim 1 including a trailer interface configured to detect a trailer connection and wherein the inverted steering angle is generated in response to a detection of a connected trailer.

4. The steering control system of claim 1 wherein the inverted steering angle is calculated in response to multiplying the steering angle by a negative unity value

5. The steering control system of claim 1 wherein the user interface is generated by a software application on a mobile device and wherein the initiation signal is transmitted via a wireless network to the steering controller.

6. The steering control system of claim 1 wherein the user interface is generated by a software application and is displayed on a vehicle infotainment display.

7. The steering control system of claim 1 including a direction sensor configured to detect a direction of propulsion of the vehicle and wherein the vehicle control system is configured to control the vehicle in response to the inverted steering angle in response to a reverse detected direction of propulsion and to control the vehicle in response to the steering angle in response to a detected change in the direction of propulsion from the reverse detected direction of propulsion to a forward detected direction of propulsion.

8. The steering control system of claim 1 wherein the vehicle control system is further configured to detect a direction of propulsion and a trailer connection state and to generate a user alert in response to the direction of propulsion being in a forward direction and the trailer connection state indicating an absence of a connected trailer.

9. The steering control system of claim 1 wherein the steering controller is configured to perform a variable rate steering algorithm and wherein the inverted steering angle has an opposite value to the steering angle.

10. A method for controlling a steering of a vehicle comprising:
receiving, by a user interface, a user input indicative of an initiation of a reverse steering feature;
detecting, by a steering sensor, a steering angle;
generating, by a vehicle control system, an inverted steering angle by inverting the steering angle such that the inverted steering angle has an opposite steering direction to that of the steering angle; and
controlling, by the vehicle control system, a motion path of the vehicle in response to the inverted steering angle.

11. The method for controlling the steering of the vehicle of claim 10 including detecting, by a trailer interface, a presence of a trailer and wherein the inverted steering angle is generated in response to a detection of a connection to the trailer.

12. The method for controlling the steering of the vehicle of claim 10 including detecting, by the vehicle control system, a direction of propulsion and wherein the inverted steering angle is generated in response to the direction of propulsion being in a reverse direction.

13. The method for controlling the steering of the vehicle of claim 10 including controlling, by the vehicle control system, the motion path of the vehicle in response to the steering angle in response to detecting a change in a propulsion direction state from a reverse direction state to a forward direction state.

14. The method for controlling the steering of the vehicle of claim 10 including detecting, by a trailer interface, a change in capacitance between two connection in a trailer connection and wherein the inverted steering angle is generated in response to the detection of the change in capacitance.

15. The method for controlling the steering of the vehicle of 10 wherein the vehicle is controlled in response to the inverted steering angle in response to the vehicle being used in a trailering operation.

16. The method for controlling the steering of the vehicle of 10 wherein the user interface is generated by a software application on a mobile device and where the user input is transmitted via a wireless network to the vehicle control system.

17. The method for controlling the steering of the vehicle of 10 wherein the user interface is generated by a software application on a vehicle infotainment system and where the user input is transmitted via a controller area network bus to the vehicle control system.

18. The method for controlling the steering of the vehicle of 10 wherein the user interface is a physical button mounted within a vehicle cabin and wherein the user input is a voltage changed detected by the vehicle control system.

19. A driver assistance system comprising;
a sensor configured to generate a trailer control signal in response to a detection of a trailer;
a vehicle propulsion system for detecting a propulsion direction state;
a user interface for receiving a user input and for generating an initiation signal in response to the user input;
a steering sensor configured to detect a steering wheel position;
a vehicle control processor for calculating a steering angle in response to the steering wheel position, and for calculating an inverse steering angle in response to the initiation signal and the trailer control signal being indicative of a connected trailer; and
a steering controller for controlling a steering direction of the a vehicle in response to the inverse steering angle in response to the propulsion direction state being in a reverse direction, and the steering angle in response to the propulsion direction state being in a forward direction.

20. The driver assistance system of claim 19 wherein the inverse steering angle such that the inverted steering angle has a same angular magnitude as the steering angle and an opposite direction of the steering angle.
